(19) United States
(12) Patent Application Publication
(10) Pub. No.: US 2010/0083904 A1
(43) Pub. Date: Apr. 8, 2010

(54) Pet Treat Dispensing Toy

(76) Inventors: Cun-Feng Pu, Mars, PA (US); Meng-Feng Lin, Highland, CA (US); Ho-Hsin Liao, Taipei City (TW); Vincent K. Lee, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/412,488

(22) Filed: Mar. 27, 2009

(30) Foreign Application Priority Data
Oct. 3, 2008 (TW) 097138236

(51) Int. Cl. A01K 1/10

(52) U.S. Cl. 119/51.03

(57) ABSTRACT

A pet treat dispensing toy mainly includes a main shell and a bottom shell. The main shell has an upper opening and a bottom opening. The bottom shell is connected around the position of the bottom opening.

The bottom shell has a food serving area. When the bottom shell is connected with the main shell, the upper opening can communicate with the food serving area such that a pet's nose can pass the upper opening to allow the pet to lick the pet food put on the food serving area.

### BACKGROUND OF THE INVENTION

1. Field of the Invention

The present invention relates to a toy device for keeping pets active and entertained.

2. Description of the Related Art

Many pet toys can keep pets active and entertained and stimulate their intelligence. Food or treats can be placed in pet toys to attract pets in order to keep pets' (e.g. dogs') interest longer. An ideal design is to not allow pets to consume the treats easily and to spend more time on pet toys. Therefore, many efforts have centered on developing pet toys which can achieve this object.

U.S. patent publication No. 20080141948, entitled “Pet toy with palatability enhancer”, features a pet toy with a material attractive to pets. Additionally, the pet toy has holes and a chamber such that treats can be placed into the chamber via the holes. However, there is no mention of how pets eat the treats or the type of treats.

U.S. Pat. No. 6,941,895, entitled “Treat dispensing chewing toy”, discloses a curved tube with many small holes. Dogs have to shake the tube so that treats will fall out through small holes.

U.S. Pat. No. 5,813,366, entitled “Animal toy”, discloses a container for food with a small hole in its top and also a small hole in its bottom. Dogs have to shake the container so that treats will fall out through these small holes.

U.S. Pat. No. 6,098,571, entitled “Animal treat dispensing toy”, discloses a sphere having many small holes on its surface. Dogs have to shake the sphere so that treats will fall out through small holes.

In addition, U.S. Pat. Nos. 6,484,671, 6,557,496, 5,819,690, 6,427,634, 7,270,085, 6,237,538, 5,865,147, and 6,470,830 also disclose containers for food with small holes on the surfaces thereof, and dogs have to shake the container so that treats will fall out through the small holes.

U.S. Pat. No. 6,688,258, entitled “Treat dispensing pet toy and training device”, discloses a container with an opening through which a rope is inserted so that food in the container will sometimes fall out when a dog is biting the rope.

U.S. Pat. No. 5,832,877, entitled “Pet toy product with integral treat receiving receptacles”, discloses a flat flexible container with a slot. Dry food can be placed in the container and fall out through the slot when the container is compressed. U.S. Pat. No. 5,965,182 is based on a similar idea.

Pet toys in the aforementioned prior arts are basically suitable for containing dry food (e.g. biscuits). Dogs have to bite the toy and shake it or change the shape of the holes to remove the dry food.

U.S. Pat. No. 5,947,061, entitled “Pet toy product with integral treats receiving receptacles”, discloses a pet toy with a plurality of recesses on the surface thereof. Either dry food (e.g. biscuits) or moist food (e.g. peanut butter) can be placed in the recesses. U.S. Pat. Nos. 6,129,053, 7,032,541, 7,234,420, and 6,546,896 also disclose similar ideas. These inventions do not provide a container in which food can be placed. They are basically conventional artificial dog bones modified by adding grooves on the surface for placing food to change the flavor of the artificial dog bones. The patents mentioned in this paragraph are designed for placing both dry food and pasty food (e.g. peanut butter). However, the recesses or grooves are disposed on the surface such that pasty foods may easily dirty floors or carpets.

With regard to the aforementioned pet toys, the sizes of their holes or recesses are basically small, and dogs basically have to bite the toys. Thus, these toys have to be replaced often and get dirty easily, and most of them are not easy to clean.

Additionally, the pet toys mentioned above basically do not allow pet owners to adjust the operation of the pet toys, such as adjusting the degree of difficulty in reaching and eating the food.

### SUMMARY OF THE INVENTION

It is an object of the present invention to provide a device allowing pets to lick pet food, especially pasty food, such as peanut butter.

It is another object of the present invention to decrease the possibility that pets will bite the pet toy.

It is still another object of the present invention to provide a pet toy which is easy to clean.

In order to achieve the above objects, the present invention provides a pet treat dispensing toy mainly comprising a main shell and a bottom shell. The main shell comprises at least one upper opening and at least one bottom opening; the bottom shell is connected around the position of the bottom opening.

The bottom shell comprises a food serving area. When the bottom shell is connected with the position of the bottom opening of the main shell, the upper opening can communicate with the food serving area such that a pet's nose can pass through the upper opening, allowing the pet to lick the pet food put on the food serving area.

In the embodiments, the bottom shell can be removable from the main shell to be cleaned easily. Moreover, the position of the bottom shell can be adjusted to be suitable for different dogs or to increase the degree of difficulty in licking the food.

### BRIEF DESCRIPTION OF THE DRAWINGS

FIG. 1 is a schematic drawing of the use of a pet treat dispensing toy in accordance with a first embodiment of the present invention.

FIG. 2 is an exploded perspective view of a pet treat dispensing toy in accordance with the first embodiment of the present invention.

FIG. 3 is a cross-section of a pet treat dispensing toy in accordance with the first embodiment of the present invention.

FIG. 4 is an exploded perspective view of a pet treat dispensing toy in accordance with a second embodiment of the present invention.

FIG. 5 is a perspective view of a pet treat dispensing toy in accordance with the second embodiment of the present invention.

FIG. 6 is a cross-section of a pet treat dispensing toy in accordance with a third embodiment of the present invention.

FIGS. 7□8 are partial cross-section perspective views of a pet treat dispensing toy in accordance with a fourth embodiment of the present invention.

FIG. 9 is an exploded perspective view of a pet treat dispensing toy in accordance with a fifth embodiment of the present invention.

FIG. 10 is a cross-section of a pet treat dispensing toy in accordance with the fifth embodiment of the present invention.

FIG. 11 is an exploded perspective view of a pet treat dispensing toy in accordance with a sixth embodiment of the present invention.

FIG. 12 is a cross-section of a pet treat dispensing toy in accordance with the sixth embodiment of the present invention.

### □REFERENCE NUMERALS□

pet treat dispensing toy 1a, 1b, 1c, 1d, 1e, 1f

main shell 10

upper opening 11

bottom opening 12

hollow tubular member 13

main shell thread 15

marking area 151

a plurality of female locking members 16

bottom shell 30

food serving area 31

recessed area 311

rim 32

elastic contacting member 321

bottom shell thread 35

handle 36, 36a

elastic member 37

operating member 40

male locking member 41

pressing member 42

fixing member 43

pet 90

pet food 92

pasty food 921

### DETAILED DESCRIPTION OF THE PREFERRED EMBODIMENT

The advantages and innovative features of the invention will become more apparent from the following detailed description when taken in conjunction with the accompanying drawings.

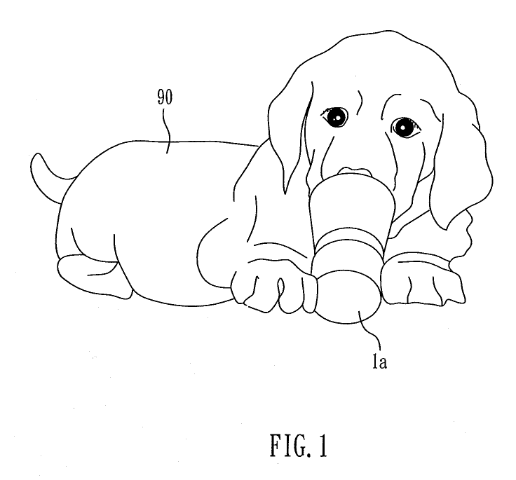

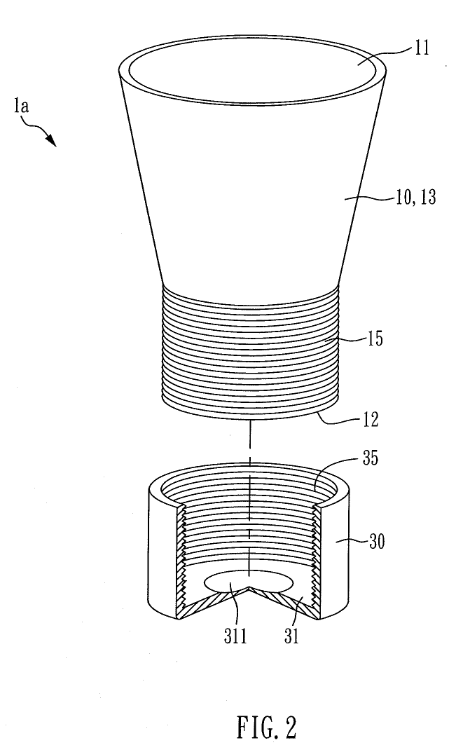

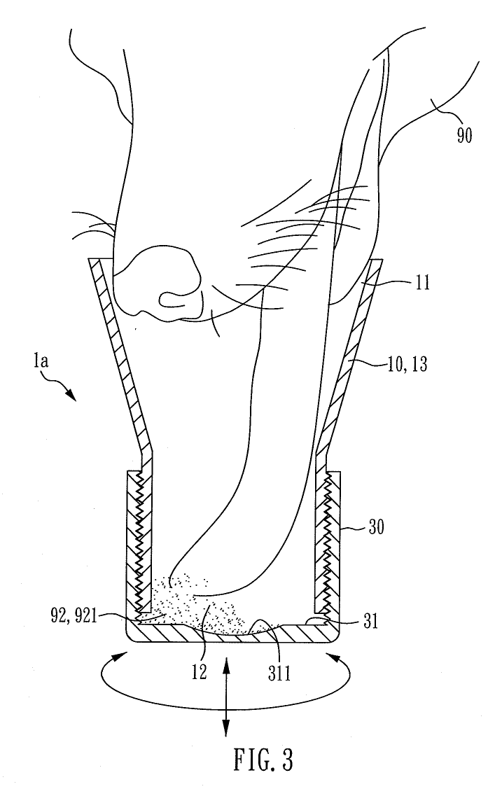

Please refer to FIGS. 1˜3 for the following paragraphs regarding the first embodiment.

The present invention provides a pet treat dispensing toy 1a mainly comprising a main shell 10 and a bottom shell 30.

The main shell 10 is substantially a hollow tubular member 13 comprising at least one upper opening 11 and at least one bottom opening 12, and the main shell 10 has a main shell thread 15 on its outer surface around the position of the bottom opening 12.

The bottom shell 30 is connected around the position of the bottom opening 12 and is substantially cup-shaped. In addition, the bottom shell 30 has a bottom shell thread 35 on its inner surface. The bottom shell thread 35 cooperates with the main shell thread 15 such that the bottom shell 30 can be attached to or detached from the main shell 10. When a user wants to clean the pet toy 1a, he or she can detach the bottom shell 30 from the main shell 10 for the convenience of cleaning.

The pet food 92 of the present invention is preferably a pasty food 921 (e.g. jam, peanut butter, etc.). The pasty food 921 is placed in the food serving area 31 of the bottom shell 30. The food serving area 31 needs to communicate with the upper opening 11 such that the pet 90's nose can pass through the upper opening 11 to allow the pet to lick the pet food 92.

The pet toy 1a of the present invention is especially suitable for a pet such as the dog 90. In order to fit most dogs' noses, the upper opening 11 of the main shell 10 is preferably larger than the bottom opening 12, and the upper opening 11 and the bottom opening 12 are circular.

Also, in order to allow the dog 90 to lick the pet food 92 for a longer time, a pet owner can adjust and set a proper distance between the upper opening 11 and the food serving area 31 by rotating the bottom shell 30. (For example, the dog can just reach the food serving area 31 with the tip of his/her tongue.) In addition, the food serving area 31 can have a recessed area 311 to increase the distance from the dog 90's tongue to the recessed area 311 when the dog 90 is licking the recessed area 311. The advantage of disposing the bottom shell 30 outside the main shell 10 is that the user can rotate the bottom shell 30 easily. However, it should be noted that the interconnection between the bottom shell thread 35 and the main shell thread 15 should not be too loose in order to prevent the dog 90 from loosening the bottom shell 30 easily or incautiously with its paw.

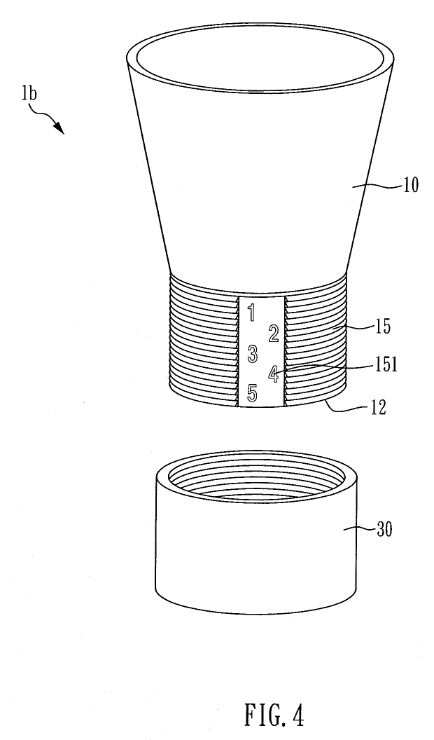

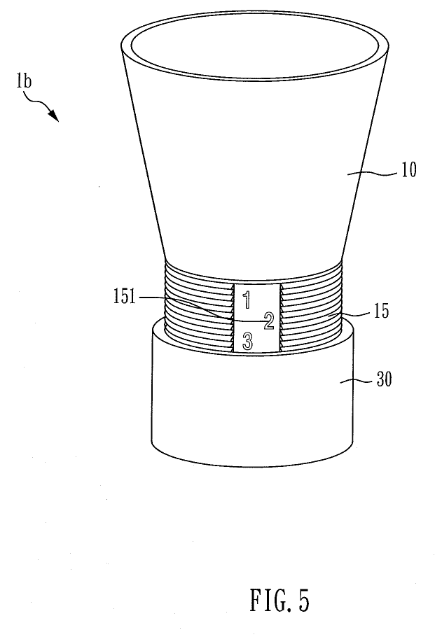

Please refer to FIGS. 4˜5 for the following regarding the second embodiment. The biggest difference between a pet treat dispensing toy 1b and the first embodiment is that some portion of the main shell thread 15 has a marking area 15, such as one marked with Arabic numerals. It is important to adjust and obtain the proper distance between the upper opening 11 and the food serving area 31, and the marking area 151 can remind the user of the proper position which has been predetermined and marked. It should be noted that the marking area 151 can be in various forms, such as letters, symbols, figures, graduations, different colors, etc.; the marking area 151 can also have a thread (e.g., shown in different colors) if this is suitable for the form of the marking area 151.

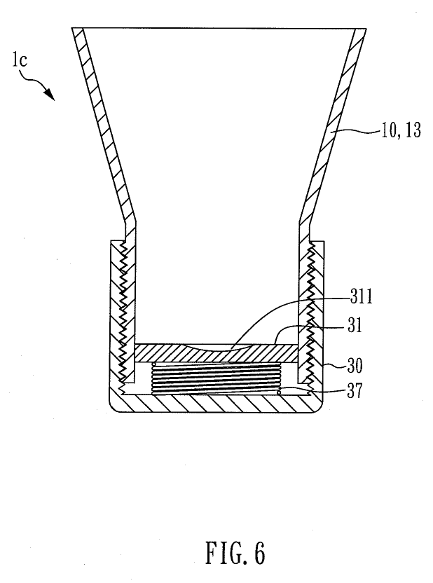

Please refer to FIG. 6 for the following regarding the third embodiment. The biggest difference between a pet treat dispensing toy 1c and the first embodiment is that the bottom shell 30 further comprises an elastic member 37 (e.g. a spring or sponge) connected with the food serving area 31. The coefficient of elasticity of the elastic member 37 should be low so that when the dog 90's tongue touches the food serving area 31, the food serving area 31 will move downward and shake, which will interest the dog in licking the food.

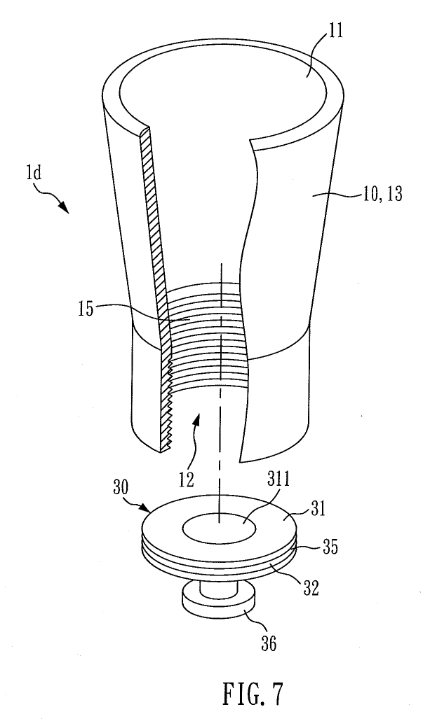

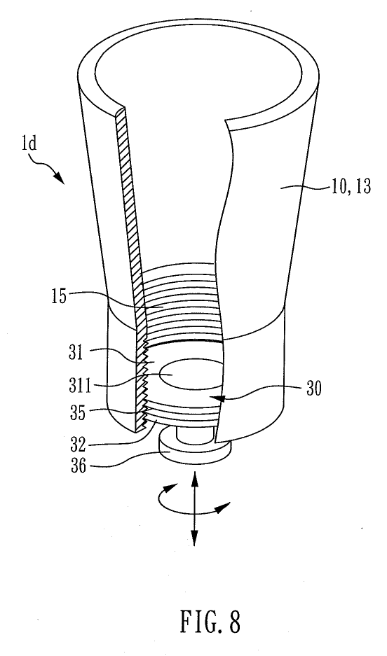

Please refer to FIGS. 7˜8 for the following regarding the fourth embodiment. The biggest difference between a pet treat dispensing toy 1d and the first embodiment is that the bottom shell 30 is disposed inside the main shell 10. Thus the main shell 10 has the main shell thread 15 on its inner surface, around the position of the bottom opening 12. Also, a rim 32 of the bottom shell 30 has a corresponding bottom shell thread 35. The pet owner can turn the handle 36 to adjust the distance between the upper opening 11 and the food serving area 31. Similarly, the food serving area 31 of the pet toy 1d can also have the recessed area 311.

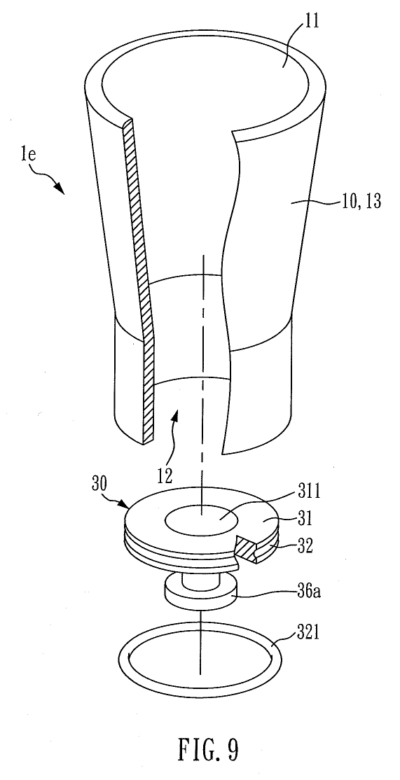

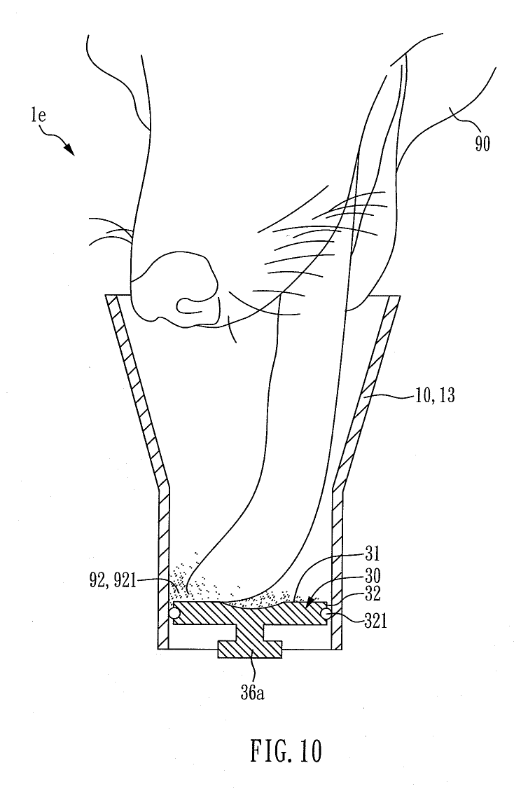

Please refer to FIGS. 9˜10 for the following regarding the fifth embodiment. The rim 32 of the bottom shell 30 of a pet treat dispensing toy 1e comprises an elastic contacting member 321 (e.g., an O-ring or flexible plastics). The bottom opening 12 is preferably circular, and the rim 32 of the bottom shell 30 is also circular. It should be noted that the bottom shell 30 itself can be made of flexible material such that the rim 32 of the bottom shell 30 has the elastic contacting member 321.

The pet owner can hold the handle 36a with his/her fingers directly and thus connect the rim 32 of the bottom shell 30 with the inner surface of the main shell 10 by friction around the position of the bottom opening 12. Also, the pet owner can hold the handle 36a and adjust and obtain the proper distance between the upper opening 11 and the food serving area 31. The friction between the bottom shell 30 and the main shell 10 should be moderate so that when the dog's tongue is touching the food serving area 31, the bottom shell 30 will move downward until the dog has no more strength to push it with the tip of his/her tongue.

The advantage of the pet toy 1e is that the proper distance between the upper opening 11 and the food serving area 31 does not need to be set by the pet owner. The food serving area 31 can be moved to a proper position when the dog is licking the food. Similarly, the food serving area 31 of the pet toy 1e can also have the recessed area 311.

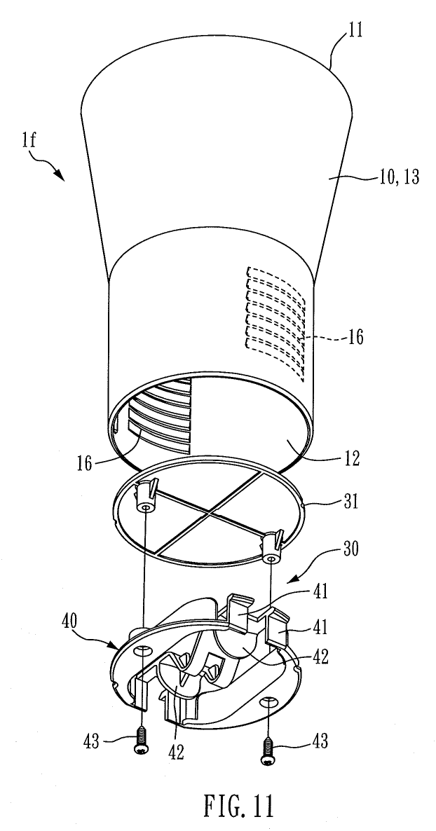

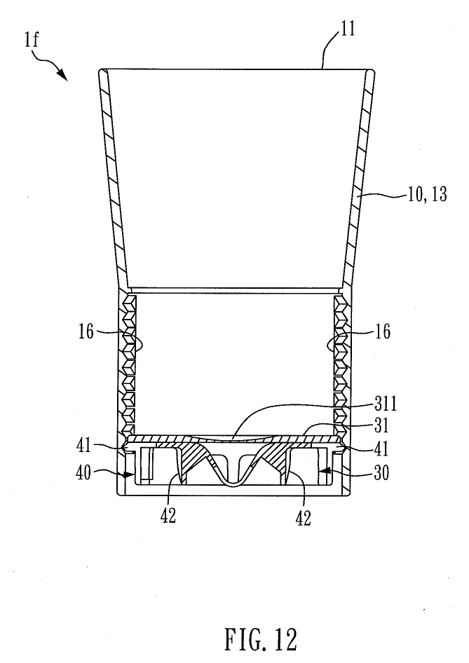

Please refer to FIGS. 11˜12 for the following regarding the sixth embodiment. The main shell 10 of a pet treat dispensing toy 1f comprises two rows of a plurality of female locking members 16 (e.g. toothed) on its inner surface around the position of the bottom opening 12. The bottom shell 30 comprises two major parts: the food serving area 31 and an operating member 40. The food serving area 31 can be connected with the operating member 40 by fixing members 43. Similarly, the food serving area 31 of the pet toy If can also have the recessed area 311.

The operating member 40 comprises a plurality of pressing members 42 and a plurality of male locking members 41 connecting with the pressing members 42. The user can operate the plurality of pressing member 42 to allow the plurality of male locking members 41 to lengthen and shorten so that the bottom shell 30 can be connected with or detached from the plurality of female locking members 16 of the main shell 10 by the plurality of male locking members 41. This can also adjust the distance between the upper opening 11 and the food serving area 31. The cooperation between the female locking members 16 and the male locking members 41 is well-known in the prior art and is thus not described here.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A pet treat dispensing toy in which pet food can be placed for a pet to lick the pet food, the pet treat dispensing toy comprising:
a main shell comprising at least one upper opening and at least one bottom opening; and
a bottom shell connected around the position of the bottom opening, detachable from the main shell, wherein the bottom shell comprises a food serving area communicating with the upper opening when the bottom shell is connected with the position of the bottom opening of the main shell;
whereby the pet food can be placed in the food serving area, and the pet's nose can pass through the upper opening to allow the pet to lick the pet food; a user can detach the bottom shell from the main shell for the convenience of cleaning.

2. The pet treat dispensing toy as claimed in claim 1, wherein the bottom shell can adjust the position at which the main shell is connected with the bottom shell such that the distance between the upper opening and the food serving area can be changed.

3. The pet treat dispensing toy as claimed in claim 2, wherein the bottom shell has a bottom shell thread, and the main shell has a main shell thread on its outer surface around the position of the bottom opening such that the bottom shell can be connected with or detached from the main shell, and the distance between the upper opening and the food serving area can be adjusted.

4. The pet treat dispensing toy as claimed in claim 3, wherein some portion of the main shell thread has a marking area.

5. The pet treat dispensing toy as claimed in claim 2, wherein the main shell is substantially a hollow tubular member.

6. The pet treat dispensing toy as claimed in claim 5, wherein the bottom shell is disposed outside the main shell.

7. The pet treat dispensing toy as claimed in claim 6, wherein the upper opening is larger than the bottom opening.

8. The pet treat dispensing toy as claimed in claim 7, wherein the bottom shell is substantially cup-shaped.

9. The pet treat dispensing toy as claimed in claim 8, wherein the bottom shell has a bottom shell thread, and the main shell has a main shell thread on its outer surface around the position of the bottom opening such that the bottom shell can be connected with or detached from the main shell, and the distance between the upper opening and the food serving area can be adjusted.

10. The pet treat dispensing toy as claimed in claim 9, wherein the food serving area comprises a recessed area.

11. The pet treat dispensing toy as claimed in claim 9, wherein some portion of the main shell thread has a marking area.

12. The pet treat dispensing toy as claimed in claim 8, wherein the bottom shell further comprises an elastic member connected with the food serving area.

13. The pet treat dispensing toy as claimed in claim 12, wherein the food serving area comprises a recessed area.

14. The pet treat dispensing toy as claimed in claim 2, wherein the bottom shell is disposed inside the main shell.

15. The pet treat dispensing toy as claimed in claim 14, wherein the bottom shell has a bottom shell thread, and the main shell has a main shell thread on its inner surface around the position of the bottom opening such that the bottom shell can be connected with or detached from the main shell, and the distance between the upper opening and the food serving area can be adjusted.

16. The pet treat dispensing toy as claimed in claim 14, wherein the bottom shell comprises a rim connected with the inner surface of the main shell by friction around the position of the bottom opening.

17. The pet treat dispensing toy as claimed in claim 16, wherein the rim of the bottom shell comprises an elastic contacting member.

18. The pet treat dispensing toy as claimed in claim 14, wherein the main shell comprises a plurality of female locking members on its inner surface around the position of the bottom opening; the bottom shell comprises a plurality of male locking members such that the bottom shell can be connected with or detached from the main shell by a plurality of male locking members, and the distance between the upper opening and the food serving area can be adjusted.

19. The pet treat dispensing toy as claimed in claim 18, wherein the bottom shell further comprises a plurality of pressing members such that the plurality of male locking members can be controlled by operating the plurality of pressing members.

20. The pet treat dispensing toy as claimed in claim 19, wherein the food serving area comprises a recessed area.
